(19) United States
(12) Patent Application Publication
(10) Pub. No.: US 2024/0416822 A1
(43) Pub. Date: Dec. 19, 2024

(54) SYSTEMS AND METHODS FOR ADJUSTABLE MOBILE STORAGE FOR VEHICLE CARGO

(71) Applicant: The Bower Co., Vancouver, WA (US)

(72) Inventor: Robert Zajac, Vancouver, WA (US)

(21) Appl. No.: 18/335,888

(22) Filed: Jun. 15, 2023

(51) Int. Cl. B60P 7/08

(52) U.S. Cl. CPC B60P 7/0815

(57) ABSTRACT

Methods and systems are provided for storage of cargo within a vehicle. In one example, a mobile storage assembly for a vehicle cargo compartment comprises a rail mount coupled to a first rail via a shaft inserted through each of an opening of the first rail and an opening of the rail mount, with the first rail positioned on a first side of a stationary component of the vehicle cargo compartment and the rail mount positioned on a second side of the stationary component. The mobile storage assembly additionally comprises a first shelf bracket inserted into the first rail and a second shelf bracket inserted into a second rail, and a shelf positioned on the first shelf bracket and the second shelf bracket.

### FIELD

The present description relates generally to methods and systems for storage of cargo within a vehicle.

### BACKGROUND/SUMMARY

Some vehicles, such as box trucks and vans, include cargo compartments for storage and/or hauling of cargo. The cargo compartments of such vehicles are often much larger than trunks or frunks of passenger vehicles such as sedans, hatchbacks, etc. Some cargo compartments include rails spaced apart from vehicle walls to reduce a likelihood of degradation of the vehicle walls resulting from movement of cargo and/or incidental contact of tools or other items with the vehicle walls. Further, cables, rope, etc. may be coupled to the rails to provide some securement of cargo stored within the cargo compartment. In some vehicles, shelving may be included within the cargo compartment by permanently welding shelf brackets to the vehicle walls. In other vehicles, holes may be drilled or otherwise formed in the compartment rails and/or the vehicle walls to accommodate the shelf brackets.

However, the inventor herein has recognized potential issues with such configurations. As one example, some users may rent, lease, or otherwise temporarily utilize a vehicle including a cargo compartment in order to deliver cargo or otherwise transport cargo between different locations, and modifications to the compartment rails within the cargo compartment and/or modifications to the vehicle walls, such as drilling holes within the compartment rails and/or vehicle walls and/or welding brackets to the vehicle walls, may result in degradation of the vehicle and may be prohibited by the vehicle owner As another example, permanent shelving for installation within a cargo compartment may be shaped specifically for a given cargo compartment configuration and may not be compatible with other cargo compartment configurations. As yet another example, permanent shelving for installation within a cargo compartment may have limited adjustability due to the welding of the shelving to the vehicle walls and/or bolting of the shelving through holes formed in the vehicle rails and/or vehicle walls, which may reduce an ease of use of the shelving and/or reduce a cargo storage capacity of the shelving (e.g., cargo storage capacity may be limited by a sheer strength of bolts inserted through the shelving and the compartment rails or vehicle walls).

In one example, the issues described above may be addressed by a mobile storage assembly for a vehicle cargo compartment comprises a rail mount coupled to a first rail via a shaft inserted through each of an opening of the first rail and an opening of the rail mount, with the first rail positioned on a first side of a stationary component of the vehicle cargo compartment and the rail mount positioned on a second side of the stationary component. The mobile storage assembly additionally comprises a first shelf bracket inserted into the first rail and a second shelf bracket inserted into a second rail, and a shelf positioned on the first shelf bracket and the second shelf bracket. In this way, the mobile storage assembly may be easily coupled or decoupled from cargo compartment rails without drilling holes into the cargo compartment rails or vehicle walls or otherwise permanently modifying the components of the vehicle.

As one example, the rail mount may fit within a clearance between the stationary component and a wall supporting the stationary component. The rail mount may engage directly with the stationary component to maintain the position of the first rail relative to the stationary component without modifying (e.g., drilling, cutting, etc.) the stationary component. As another example, the rail mount may be shaped to seat within slots of the stationary component and may engage with the stationary component via the slots to support the first rail without modifying the stationary component.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a perspective view of a vehicle including a cargo compartment.

FIG. 2 shows a rear view of a cargo compartment of a vehicle including a plurality of compartment rails.

FIG. 3 shows a sectional view of the cargo compartment and compartment rails of FIG. 2.

FIG. 4 shows a perspective view of a mobile storage assembly for a cargo compartment of a vehicle.

FIG. 5 shows a side view of a storage unit of the mobile storage assembly of FIG. 4.

FIG. 6 shows an enlarged view of a rail mount of the storage unit of FIG. 5.

FIG. 7 shows an enlarged view of a support foot of a vertical rail of the storage unit of FIG. 5.

FIG. 8 shows an enlarged sectional view of the rail mount of FIG. 6.

FIG. 9 shows a top view of the vertical rail of the storage unit of FIG. 5.

FIG. 10 shows a front view of the vertical rail of the storage unit of FIG. 5.

FIG. 11 shows a side sectional view of the vertical rail of the storage unit of FIG. 5 with a support brace coupled to the vertical rail.

FIG. 12 shows a perspective view of rails of another mobile storage assembly for a cargo compartment of a vehicle.

FIG. 13 shows a perspective view of a spacing guide for mobile storage assembly rails.

FIG. 14 shows an enlarged view of the mobile storage assembly rails of FIG. 12.

FIG. 15 shows a side view of a rail mount for the mobile storage assembly rails of FIG. 12, with the rail mount in a disengaged configuration.

FIG. 16 shows a side view of the rail mount of FIG. 15 in an engaged configuration.

FIG. 17 shows a method for assembling a mobile storage assembly within a cargo compartment of a vehicle.

FIG. 18 shows a method for relocating a mobile storage assembly from a first vehicle cargo compartment to a second vehicle cargo compartment.

### DETAILED DESCRIPTION

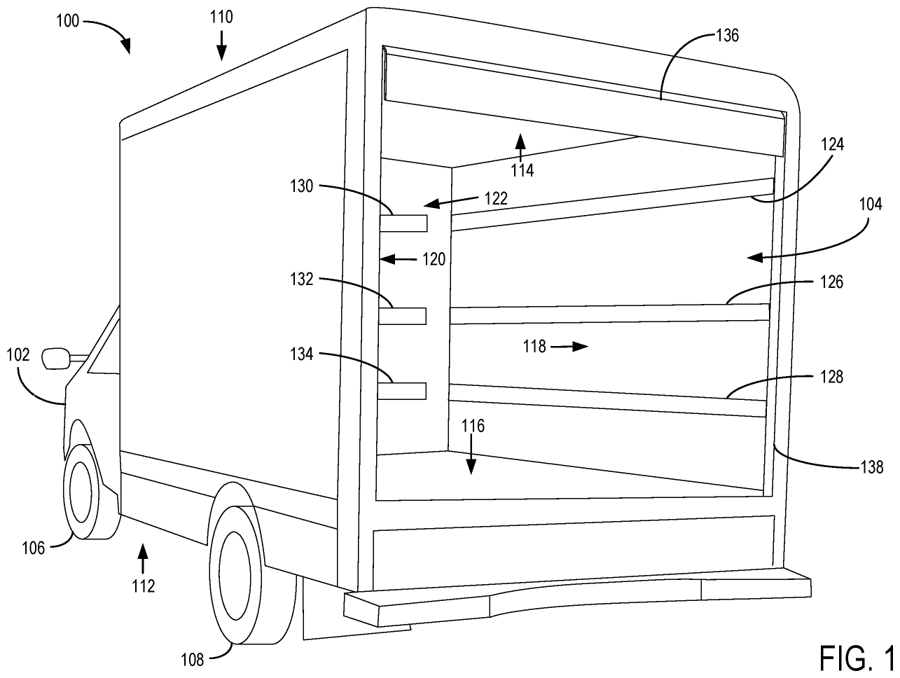

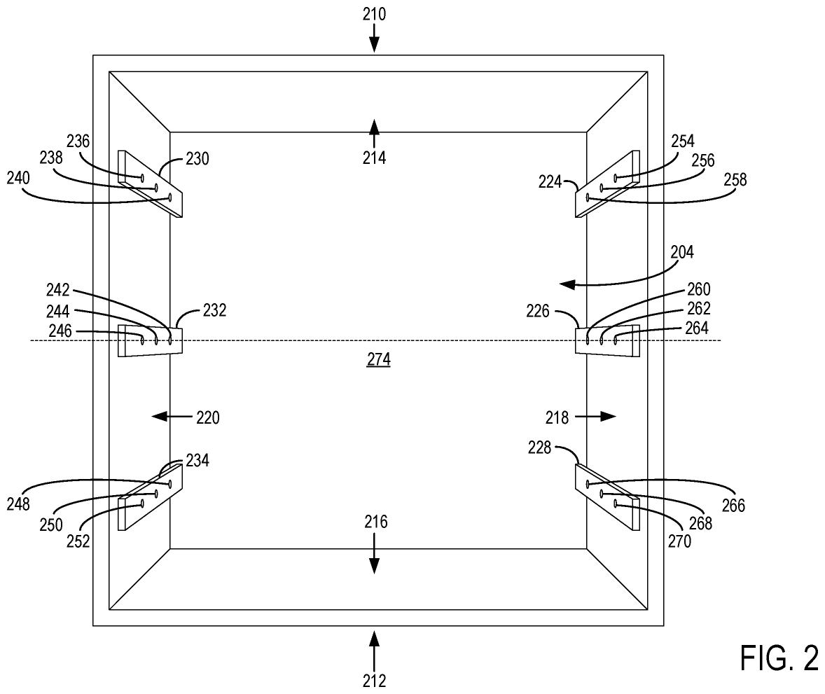

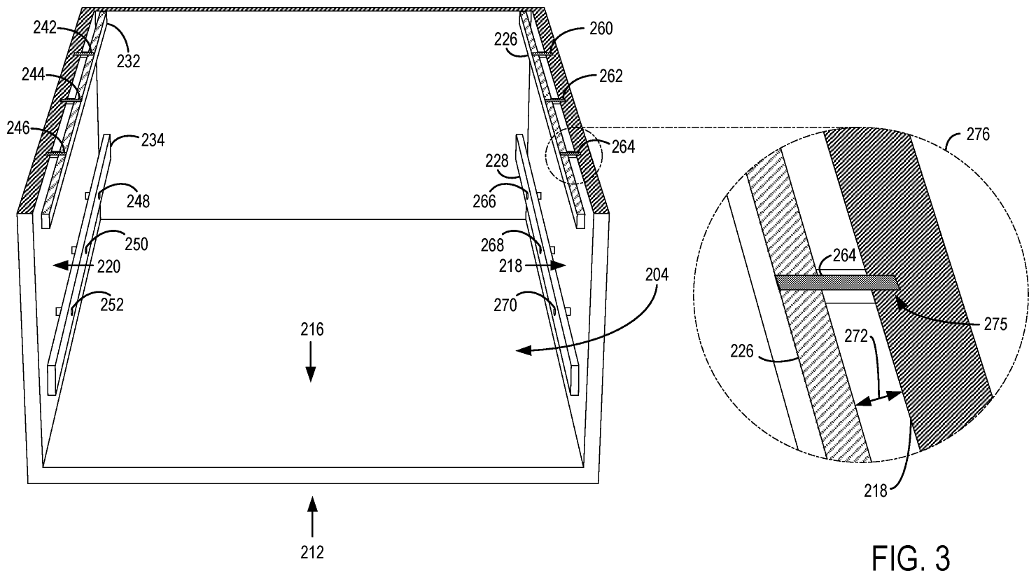

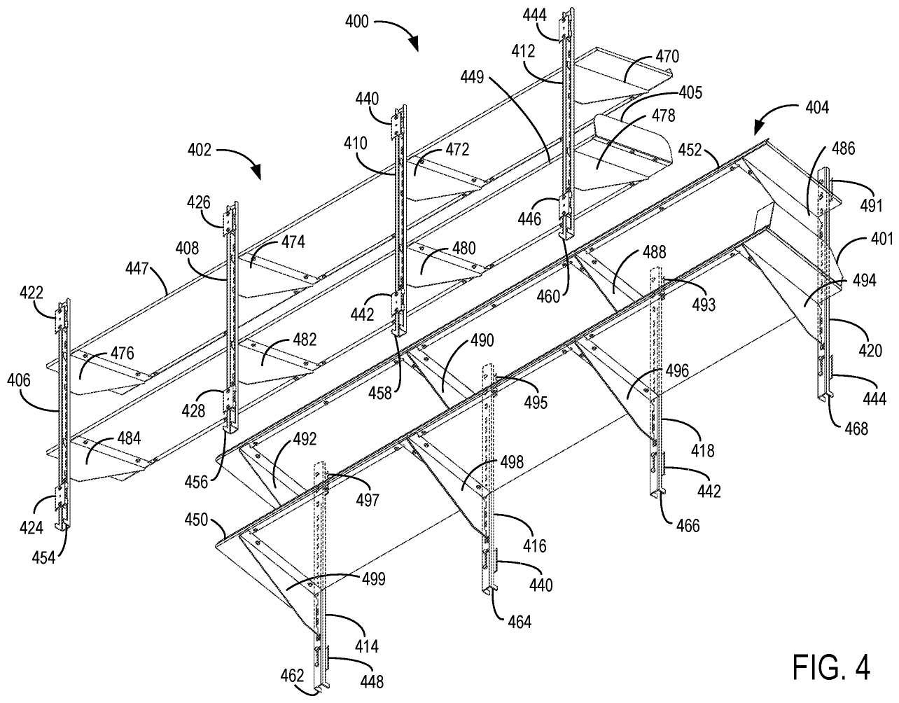

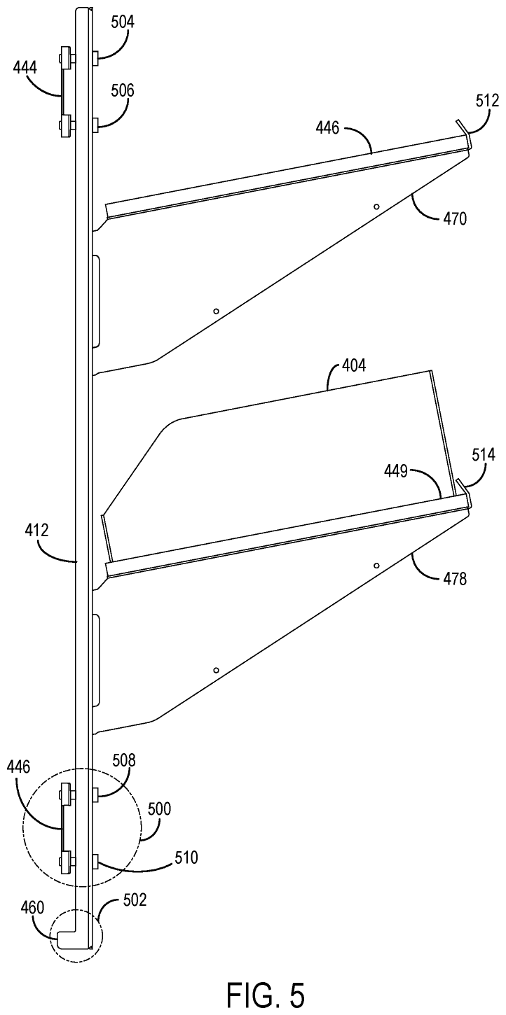

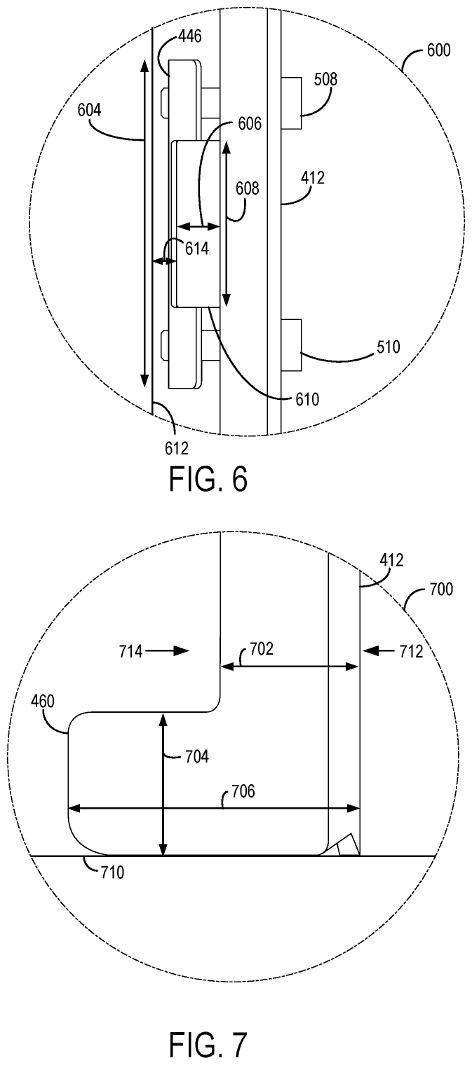

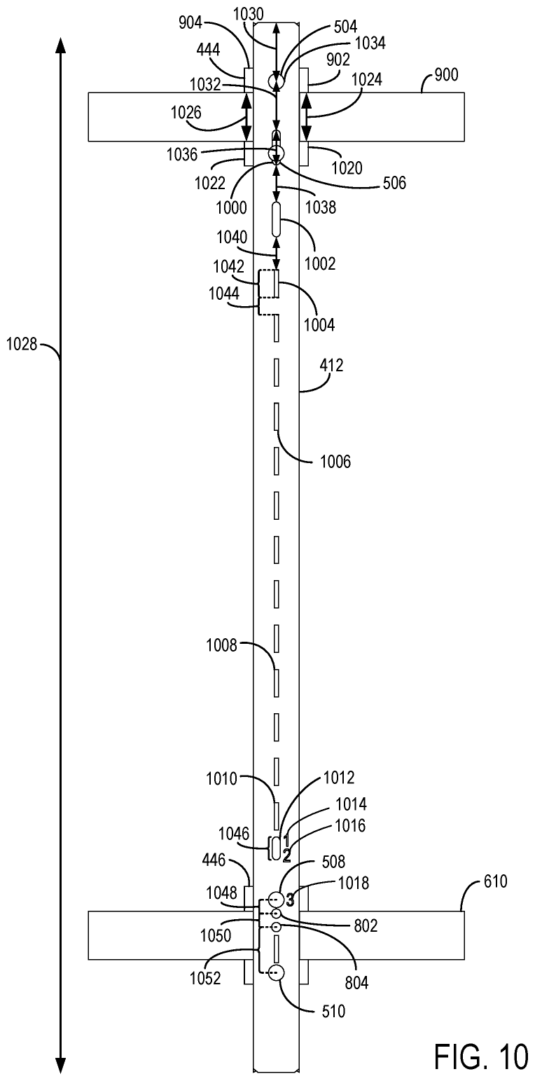

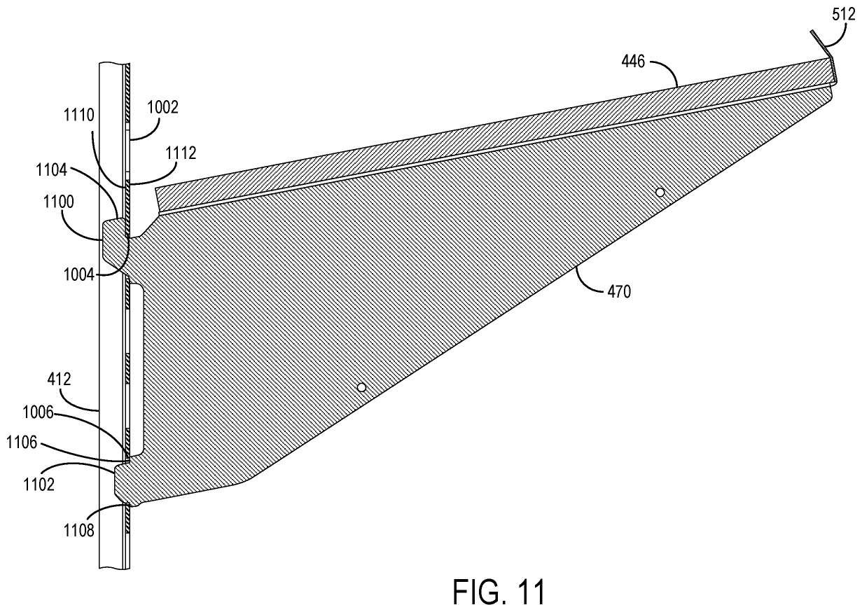

The following description relates to systems and methods for storage of cargo within a vehicle. A vehicle, such as the vehicle shown by FIG. 1, may include a cargo storage compartment, such as the cargo storage compartment shown by FIGS. 2-3. The cargo storage compartment may include compartment rails fixed to vehicle walls forming the cargo compartment, with clearances formed between the compartment rails and the vehicle walls. A mobile storage assembly, such as the mobile storage assembly shown by FIG. 4, includes a plurality of vertical rails and a plurality of rail mounts, such as the vertical rail and rail mount shown by FIG. 5. The vertical rails of the mobile storage assembly may be secured to the compartment rails via the rail mounts without drilling or otherwise forming holes within the compartment rails and/or vehicle walls. In particular, the vertical rails may be secured to the compartment rails by coupling the rail mounts to the vertical rails while the compartment rails are between the rail mounts and the vertical rails, as shown by FIGS. 6 and 8-9. Each vertical rail may include a plurality of openings, as shown by FIG. 10, with the openings shaped to receive support braces, such as the support brace shown by FIG. 11. The support braces may be adjusted to various different positions by coupling the support braces to different openings of the vertical rails. In some examples, one or more of the vertical rails may include a support foot, such as the support foot shown by FIG. 7, with the support foot shaped to seat against a floor surface of the cargo compartment to increase a load-bearing capacity and/or stability of the mobile storage assembly.

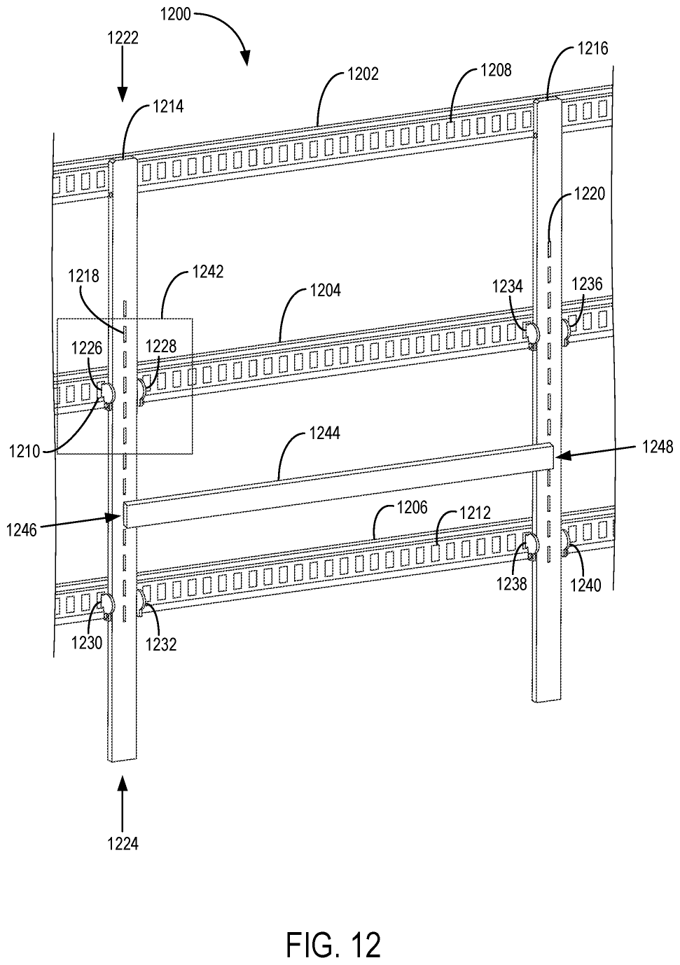

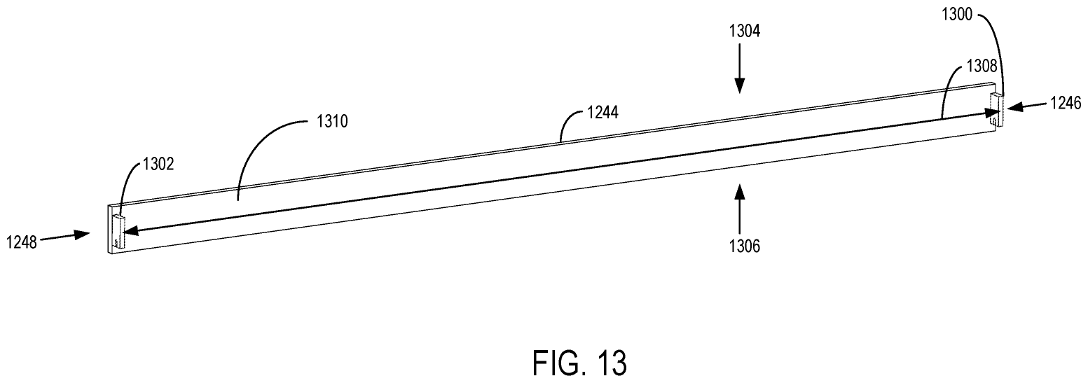

In some embodiments, each rail mount of the mobile storage assembly may include a respective protrusion shaped to seat within a corresponding slot of a compartment rail of a cargo compartment, as shown by FIGS. 12 and 14-16. A spacing between adjacent vertical rails of the mobile storage assembly may be guided by way of a spacing guide of the mobile storage assembly, as shown by FIG. 13.

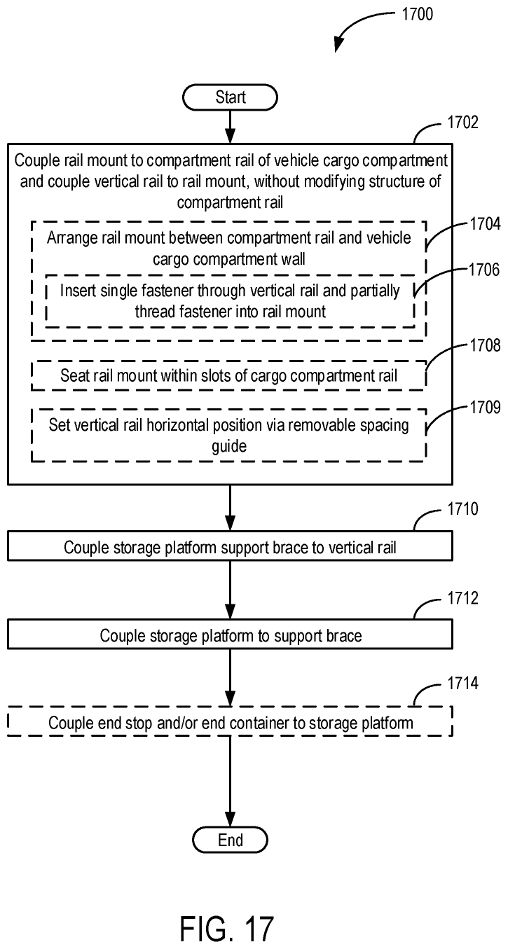

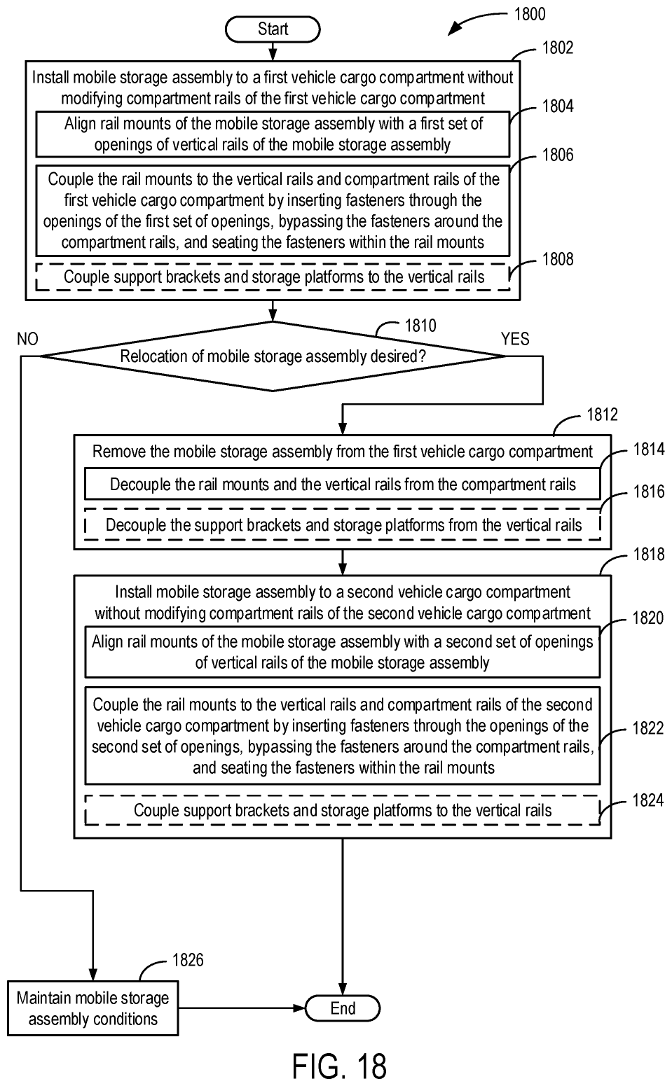

The mobile storage assembly described herein may thus increase an ease of cargo storage within a vehicle and may be installed to the vehicle without modification of vehicle components such as cargo compartment rails or vehicle walls, according to the methods described herein and as shown by the flowcharts of FIGS. 17-18. Further, the mobile storage assembly may be decoupled from the vehicle and installed to a different vehicle having a different cargo compartment configuration without additional components. As a result, the mobile storage assembly may be easily moved from one vehicle to another without degradation of the components of each vehicle and may provide increased cargo organization for a variety of different vehicles.

Referring to FIG. 1, a perspective view of an example vehicle 100 including a cargo compartment 104 is shown. The cargo compartments described herein may be referred to as cargo storage compartments, vehicle cargo compartments, etc. In the example shown by FIG. 1, vehicle 100 is a box truck including a cab 102, a plurality of wheels such as wheel 106 and wheel 108, and cargo compartment 104. The vehicle 100 is one example of a vehicle that may include a mobile storage assembly as described herein. However, in other examples, the vehicle 100 may be a different type of vehicle including a cargo compartment, such as a cargo van. The phrase “cargo compartment,” as described herein, refers to a large chamber (e.g., space) within the vehicle that is shaped to store cargo, such as boxes, packages, or other items and may be sized such that a user (e.g., operator of the vehicle) may stand upright within the cargo compartment (e.g., to move cargo from one location to another within the cargo compartment, to remove cargo from the cargo compartment, etc.). The phrase “cargo compartment” does not refer to a trunk or frunk (e.g., front trunk) of a passenger vehicle. The phrase “cargo compartment” additionally does not refer to a cabin of the vehicle (e.g., a compartment in which one or more users of the vehicle reside during propulsion of the vehicle) or a bed of the vehicle that is not fully enclosed (e.g., a bed of a flatbed truck, with or without a removable canopy). As one example, a cargo compartment as described herein may have a length of 10 feet, a width of 6 feet, and a height of 6 feet. As another example, a cargo compartment may have a length of 12 feet, a width of 5 feet, and a height of 7 feet. Other examples are possible.

The cargo compartment 104 shown by FIG. 1 includes a compartment ceiling 114 arranged toward an upper end 110 of the vehicle 100 and a compartment floor 116 arranged toward a lower end 112 of the vehicle, where the compartment ceiling 114 is opposite to the compartment floor 116 and the upper end 110 is opposite to the lower end 112. The compartment ceiling 114 and the compartment floor 116 may be approximately flat (e.g., planar) and may be parallel to each other. The cargo compartment 104 further includes a compartment side wall 118, an opposing compartment side wall 120, and a compartment end wall 122. The compartment side wall 118 may be arranged parallel to the compartment side wall 120, and each of the compartment side wall 118 and the compartment side wall 120 may be arranged approximately perpendicular to each of the compartment ceiling 114 and the compartment floor 116. Further, the compartment end wall 122 may be approximately perpendicular to each of the compartment ceiling 114, the compartment floor 116, the compartment side wall 118, and the compartment side wall 120. In the example shown, the cargo compartment 104 may be closed by door 136, which may be a rolling door. In other examples, the door 136 may be a different type of door (e.g., a double door with hinges).

The cargo compartment 104 additionally includes a plurality of compartment rails fixed to the walls of the vehicle defining the cargo compartment 104. The compartment rails described herein may be referred to as stationary components of the vehicle (e.g., the compartment rails are securely fixed within the cargo compartment 104, are supported by walls of the cargo compartment 104, and do not move relative to the walls of the cargo compartment). In the example shown by FIG. 1, the cargo compartment 104 includes compartment rail 124, compartment rail 126, and compartment rail 128 fixed to compartment side wall 118, and compartment rail 130, compartment rail 132, and compartment rail 134 fixed to compartment end wall 122. The cargo compartment 104 may additionally include a plurality of compartment rails fixed to the compartment side wall 120, similar to the example described below with reference to FIGS. 2-3. In some examples, the compartment rails may be fixed to the compartment side wall 120 and the compartment side wall 118 and may not be fixed to the compartment end wall 122. In the example shown by FIG. 1, the compartment rails are arranged horizontally such that the compartment rails extend approximately parallel with the compartment ceiling 114 and the compartment floor 116, with a first end of each compartment rail arranged toward the cab 102 and with an opposing, second end of each compartment rail arranged away from the cab 102 and toward opening 138 shaped to be sealed by door 136. However, in other examples, the compartment rails may extend in a vertical direction, perpendicular to the horizontal direction (e.g., with the first end of each compartment rail arranged toward the upper end 110 of the vehicle 100 and with the second end of each compartment rail arranged toward the lower end 112 of the vehicle 100). For vehicle configurations that include compartment rails extending in the vertical direction, the coupling of the mobile storage assembly as described herein to the compartment rails may be similar to the coupling of the mobile storage assembly to horizontal compartment rails (e.g., in each configuration, the compartment rails are arranged between rail mounts of the mobile storage assembly and vertical rails of the mobile storage assembly during conditions in which the mobile storage assembly is coupled to the compartment rails). The compartment rails may be formed from a wood material or a metal material, in some examples.

The vehicle 100 is an example vehicle that may include a mobile storage assembly as described herein. A mobile storage assembly, such as the mobile storage assembly described below with reference to FIGS. 3-11, may be installed within the cargo storage compartment 104 of the vehicle 100. The mobile storage assembly is configured to be installed to the cargo storage compartment 104 of the vehicle 100 without modifying the compartment rails, such as compartment rail 124, compartment rail 126, and compartment rail 128, and without modifying the compartment walls, such as compartment side wall 118, compartment side wall 120, and compartment end wall 122. In particular, the mobile storage assembly may be installed to the cargo storage compartment 104 without forming holes (e.g., drilling) or welding to either the compartment rails or the walls of the vehicle 100. Further, because installation of the mobile storage assembly does not include modification of the compartment rails or vehicle walls, the mobile storage assembly may be easily removed from the cargo storage compartment 104 as desired by the operator of the vehicle 100.

Referring to FIG. 2, a rear view of another example cargo storage compartment 204 is shown. The cargo storage compartment 204 shown by FIG. 2 may be similar to, or the same as, the cargo storage compartment 104 shown by FIG. 1 and described above. For example, the cargo storage compartment 204 may be included within a vehicle such as the vehicle 100 described above with reference to FIG. 1. In other examples the cargo storage compartment 204 may be included within a different vehicle.

Several of the features described with regard to cargo storage compartment 204 may be similar to, or the same as, the features described with regard to cargo storage compartment 104 shown by FIG. 1. For example, the cargo storage compartment 204 includes compartment ceiling 214 arranged at an upper end 210 of a vehicle, compartment floor 216 arranged at a lower end 212 of the vehicle, compartment side wall 218, compartment side wall 220, and compartment end wall 274, which may be similar to, or the same as, the compartment ceiling 114, compartment floor 116, compartment side wall 118, compartment side wall 120, and compartment end wall 122, respectively, described above with reference to FIG. 1. The cargo storage compartment 204 additionally includes compartment rail 224, compartment rail 226, and compartment rail 228, which may be similar to, or the same as, the compartment rail 124, compartment rail 126, and compartment rail 128, respectively, described above with reference to FIG. 1. The compartment rail 224, compartment rail 226, and compartment rail 228 are shown fastened to the compartment side wall 218 via a plurality of fasteners. In the example shown by FIG. 2, the cargo storage compartment 204 further includes compartment rail 230, compartment rail 232, and compartment rail 234 fastened to the compartment side wall 220 via a plurality of fasteners.

The fasteners securing (e.g., coupling) the compartment rails to the vehicle walls may be bolts, in some examples. The compartment rail 224 is shown secured to the compartment side wall 218 by fastener 254, fastener 256, and fastener 258, the compartment rail 226 is shown secured to the compartment side wall 218 by fastener 260, fastener 262, and fastener 264, and the compartment rail 228 is shown secured to the compartment side wall 218 by fastener 266, fastener 268, and fastener 270. The compartment rail 230 is shown secured to the compartment side wall 220 by fastener 236, fastener 238, and fastener 240, the compartment rail 232 is shown secured to the compartment side wall 220 by fastener 242, fastener 244, and fastener 246, and the compartment rail 234 is shown secured to the compartment side wall 220 by fastener 248, fastener 250, and fastener 252.

In the sectional view of the cargo storage compartment 204 shown by FIG. 3, the fasteners are shown extending through the compartment rails and into the vehicle walls. For example, as shown by the enlarged view of inset 276, the fastener 264 extends through the compartment rail 226 and into the compartment side wall 218, with an end portion 275 of the fastener 264 seated within the compartment side wall 218. In this configuration, the fastener 264 (along with fastener 260 and fastener 262) maintains the position of the compartment rail 226 relative to the compartment side wall 218. In particular, the compartment rail 226 is maintained spaced apart from the compartment side wall 218 by clearance 272 between the compartment rail 226 and the compartment side wall 218. In some examples, a length of the clearance 272 from the compartment rail 226 to the compartment side wall 218 may be approximately one inch. However, in other examples, the length of the clearance 272 may be different (e.g., 0.5 inches, 1.5 inches, etc.).

Each compartment rail may be similarly coupled to the vehicle walls as described above. For example, compartment rail 228 may be coupled to compartment side wall 218 via fastener 266, fastener 268, and fastener 270, and may be spaced apart from the compartment side wall 218 such that a clearance is formed between the compartment rail 228 and the compartment side wall 218. The clearance between the compartment rail 228 and the compartment side wall 218 may be similar to the clearance 272 described above (e.g., the clearance between the compartment rail 228 and the compartment side wall 218 may have the same length as the clearance 272). The compartment rails coupled to the compartment side wall 220 may have a similar configuration (e.g., each compartment rail coupled to the compartment side wall 220 may be spaced apart from the compartment side wall 220 by a respective clearance having a same length as clearance 272). As described below, the clearances between the compartment rails and the compartment side walls may provide space for rail mounts of a mobile storage assembly to secure to vertical rails of the mobile storage assembly to install the mobile storage assembly to the cargo compartment 204 without modification (e.g., drilling) of the compartment rails, vehicle walls, etc. In some examples, no portion of the mobile storage assembly extends into the compartment rails and no portion of the mobile storage assembly extends into the compartment side walls.

Referring to FIG. 4, a perspective view of a mobile storage assembly 400 is shown. The mobile storage assembly 400 may be installed to a cargo compartment of a vehicle, such as the cargo compartment 104 shown by FIG. 1 and described above, or the cargo compartment 204 shown by FIGS. 2-3 and described above. The mobile storage assembly 400 may be installed or removed from a vehicle cargo compartment without modification of the vehicle or components of the vehicle cargo compartment, as described below. As a result, the mobile storage assembly 400 may provide versatile and adaptable cargo organization for a variety of different cargo compartment configurations.

In the example shown by FIG. 4, the mobile storage assembly 400 includes a first storage unit 402 and a second storage unit 404. The first storage unit 402 and the second storage unit 404 may each include similar components, as described below. Although the mobile storage assembly 400 includes the first storage unit 402 and the second storage unit 404 in the example shown, in other examples the mobile storage assembly 400 may include the first storage unit 402 and not the second storage unit 404, or the mobile storage assembly 400 may include the second storage unit 404 and not the first storage unit 402. In configurations in which the mobile storage assembly includes the first storage unit 402 and not the second storage unit 404, the first storage unit 402 may be referred to as the mobile storage assembly, and in configurations in which the mobile storage assembly includes the second storage unit 404 and not the first storage unit 402, the second storage unit 404 may be referred to as the mobile storage assembly.

The first storage unit 402 includes a plurality of components configured to secure the first storage unit 402 within a cargo compartment of a vehicle, such as the cargo compartments described above with reference to FIGS. 1-3. In particular, the first storage unit 402 includes a plurality of vertical rails, such as vertical rail 406, vertical rail 408, vertical rail 410, and vertical rail 412, as well as rail mount 422, rail mount 424, rail mount 426, rail mount 428, rail mount 440, rail mount 442, rail mount 444, and rail mount 446. The vertical rail 406 may couple to compartment rails of the cargo compartment of the vehicle via rail mount 422 and rail mount 424, the vertical rail 408 may couple to the compartment rails via rail mount 426 and rail mount 428, the vertical rail 410 may couple to the compartment rails via rail mount 440 and rail mount 442, and the vertical rail 412 may couple to the compartment rails via rail mount 444 and rail mount 446. The vertical rails are configured to couple to the compartment rails via the rail mounts without modifying (e.g., altering, such as drilling) the vehicle walls or compartment rails.

The vertical rail 406, vertical rail 408, vertical rail 410, and vertical rail 412 of the first storage unit 402 may support a plurality of support braces during conditions in which the first storage unit 402 is installed to the vehicle cargo compartment, such as support brace 470, support brace 472, support brace 474, support brace 476, support brace 478, support brace 480, support brace 482, and support brace 484. Support brace 470, support brace 472, support brace 474, and support brace 476 each couple to storage platform 447, and support brace 478, support brace 480, support brace 482, and support brace 484 each couple to storage platform 449. The storage platforms described herein may be referred to as shelves. The support braces described herein may be referred to as brackets and/or shelf brackets. During conditions in which the support braces are coupled to the vertical rails, the vertical rails may maintain the position of the support braces while the support braces maintain the position of the respective storage platforms.

In this configuration, load applied to the storage platforms is applied through the respective coupled support braces to the vertical rails, and the load applied to the vertical rails through the support braces is applied to the compartment rails via the rail mounts coupling the vertical rails to the compartment rails. In this way, the storage platforms may support a large amount of load (e.g., 1000 lbs, 2000 lbs, etc.) without modification of the compartment rails or vehicle walls.

The second storage unit 404 may include a configuration of support braces, vertical rails, rail mounts, and storage platforms similar to the configuration described above with reference to the first storage unit 402. For example, as shown by FIG. 4, the second storage unit 404 may include vertical rail 414, vertical rail 416, vertical rail 418, and vertical rail 420, which may provide support for storage platform 452 via support brace 486, support brace 488, support brace 490, and support brace 492. The vertical rail 414, vertical rail 416, vertical rail 418, and vertical rail 420 may additionally provide support for storage platform 450 via support brace 494, support brace 496, support brace 498, and support brace 499. The vertical rail 414, vertical rail 416, vertical rail 418, and vertical rail 420 may be secured to the compartment rails of the vehicle cargo compartment via the rail mounts, with vertical rail 414 coupling to the compartment rails via rail mount 448 and rail mount 497, with vertical rail 416 coupling to the compartment rails via rail mount 440 and rail mount 495, with vertical rail 418 coupling to the compartment rails via rail mount 442 and rail mount 493, and with vertical rail 420 coupling to the compartment rails via rail mount 444 and rail mount 491. Some of the portions of the second storage unit 404 arranged behind other features in the view shown by FIG. 4 are drawn in broken lines.

The mobile storage assembly 400 may further include one or more end stops, such as end stop 405, and one or more end containers, such as end container 401. The end stops may reduce a likelihood of undesired movement of cargo supported by the storage platforms of the mobile storage assembly 400, and the end containers may provide additional organization of smaller cargo such as small parcels or envelopes. In some examples, the end stops and/or end containers may be removable from the storage platforms for replacement, maintenance, etc.

In the example shown by FIG. 4, each of the vertical rails includes a respective support foot shaped to engage directly with the compartment floor of the vehicle cargo compartment to which the mobile storage assembly 400 is installed. In particular, vertical rail 406 includes support foot 454, vertical rail 408 includes support foot 456, vertical rail 410 includes support foot 458, vertical rail 412 includes support foot 460, vertical rail 414 includes support foot 462, vertical rail 416 includes support foot 464, vertical rail 418 includes support foot 466, and vertical rail 420 includes support foot 468. By configuring each support foot to engage directly with the compartment floor (e.g., maintain contact directly against the compartment floor), a load capacity and/or stability of the mobile storage assembly 400 may be increased.

Referring to FIG. 5, a side view of a portion of the mobile storage assembly 400 described above with reference to FIG. 4 is shown. In particular, FIG. 5 shows a side view of vertical rail 412 including support foot 460, support brace 470, storage platform 447, support brace 478, storage platform 449, rail mount 444, and rail mount 446. Additionally, FIG. 5 shows mount fastener 504 and mount fastener 506 coupling the vertical rail 412 to rail mount 444, and mount fastener 508 and mount fastener 510 coupling the vertical rail 412 to rail mount 446. During conditions in which the vertical rail 412 is coupled to compartment rails of a vehicle cargo compartment as described above via rail mount 444 and rail mount 446, the mount fasteners do not extend through the compartment rails or the vehicle walls. In particular, the mount fastener 504, mount fastener 506, mount fastener 508, and mount fastener 510 do not extend through the compartment rails and do not extend into the vehicle walls. The mount fasteners described herein may be referred to as shafts.

In the example shown, the storage platform 447 includes an edge strip 512 and the storage platform 449 includes an edge strip 514. The edge strip 512 may provide reinforcement of the outer edge of the storage platform 447, and the edge strip 514 may provide reinforcement of the outer edge of the storage platform 449. In some examples, the edge strip 512 may be coupled to the storage platform 447 via fasteners (e.g., bolts), and the edge strip 514 may be coupled to the storage platform 449 via fasteners. In some examples, the edge strip 512 and the edge strip 514 may be formed from a material different from a material of the storage platform 447 and the storage platform 449. As one example, the storage platform 447 and the storage platform 449 may each be formed from a wood material (e.g., plywood), and the edge strip 512 and the edge strip 514 may each be formed from a metal material (e.g., steel). Other examples are possible.

Referring to FIG. 6, an enlarged view 600 of inset 500 of FIG. 5 is shown. The enlarged view 600 shows the vertical rail 412 and the rail mount 446 coupled together. Additionally, an example compartment rail 610 is shown arranged between the vertical rail 412 and the rail mount 446. The compartment rail 610 may be similar to, or the same as, the compartment rails described above with reference to FIGS. 1-3 and may be included within a cargo compartment of a vehicle.

During conditions in which the mobile storage assembly 400 is installed to the vehicle cargo compartment, the rail mount 446 is coupled to the vertical rail 412 around the compartment rail 610 (e.g., with the compartment rail 610 arranged between the rail mount 446 and the vertical rail 412). As described above with reference to FIGS. 2-3, the compartment rails of the vehicle cargo compartment may be spaced apart from the vehicle walls such that a clearance is formed between each compartment rail and the respective vehicle wall supporting each compartment rail. FIG. 6 shows compartment side wall 612 as one example vehicle wall, where the compartment side wall 612 may be similar to, or the same as, the compartment side wall 218 or the compartment side wall 220 shown by FIGS. 2-3 and described above.

In the example shown by FIG. 6, the compartment rail 610 has a length 604 in a vertical direction (e.g., a direction from a floor of the cargo compartment to a ceiling of the cargo compartment), a thickness 606 in a direction perpendicular to the vertical direction, and is spaced apart from the compartment side wall 218 by clearance 614, with the rail mount 446 arranged within the clearance 614. In particular, the rail mount 446 is shaped to fit behind the compartment rail 610 in the direction toward the compartment side wall 612. During conditions in which the rail mount 446 and the vertical rail 412 are coupled together, each of the rail mount 446 and the vertical rail 412 are pressed toward each other by engagement of the mount fastener 508 and the mount fastener 510 with each of the rail mount 446 and the vertical rail 412. The mount fastener 508 and the mount fastener 510 may be threaded fasteners including shafts, for example, and may engage with counterpart threads of the rail mount 446 to pull the rail mount 446 and the vertical rail 412 toward each other and press the rail mount 446 and the vertical rail 412 against the compartment rail 610. The rail mount 446 is shaped such that a length 604 of the rail mount 446 in the vertical direction may be larger than a length 608 of the compartment rail 610 in the vertical direction. The increased length of the rail mount 446 relative to the compartment rail 610 may increase an ease of installation of the mobile storage assembly 400 to the cargo compartment. Additionally, the rail mount 446 may include protrusions that may further maintain a position of the rail mount 446 relative to the compartment rail 610.

Referring to FIG. 7, an enlarged view 700 of inset 502 is shown. The enlarged view 700 shows support foot 460 of the vertical rail 412. Further, an example cargo compartment floor 710 is shown, with the support foot 460 engaged directly with the cargo compartment floor 710 (e.g., seated directly against the cargo compartment floor 710). The cargo compartment floor 710 may be similar to, or the same as, the compartment floor 116 shown by FIG. 1 and described above and/or the compartment floor 216 shown by FIGS. 2-3 and described above. As described above, each vertical rail may include a respective support foot which may be similar to, or the same as, the support foot 460. By configuring each vertical rail to include a support foot as described herein, the load capacity and/or stability of the mobile storage assembly 400 may be increased.

As shown by FIG. 7, each vertical rail may have a thickness 702 in a direction from a vertical rail front end 712 to a vertical rail rear end 714. During conditions in which the mobile storage assembly 400 is installed to a vehicle cargo compartment, the vertical rail 412 is configured such that a length between the vertical rail rear end 714 and the vehicle wall is less than a length between the vertical rail front end 712 and the vehicle wall, where the vehicle wall includes the compartment rails to which the vertical rails are mounted via the rail mounts of the mobile storage assembly 400. Each vertical rail 412 may have a similar configuration (e.g., a similar vertical rail front end and a similar vertical rail rear end relative to the vertical rail front end 712 and the vertical rail rear end 714, respectively, described above).

Although the support foot 460 is described herein, each vertical rail may include a similar support foot. As shown by FIG. 7, the support foot 460 has a length 706 in the direction between the vertical rail front end 712 and the vertical rail rear end 714. The length 706 may be larger than the thickness 702, such that the support foot 460 extends outward from the vertical rail 412 at the vertical rail rear end 714 (e.g., the support foot 460 extends toward the vehicle wall during conditions in which the vertical rail 412 is coupled to compartment rails via the rail mounts). The support foot 460 has a length 704 in the vertical direction perpendicular to the direction between the vertical rail front end 712 and the vertical rail rear end 714, and in some examples the length 704 may be less than the length 706.

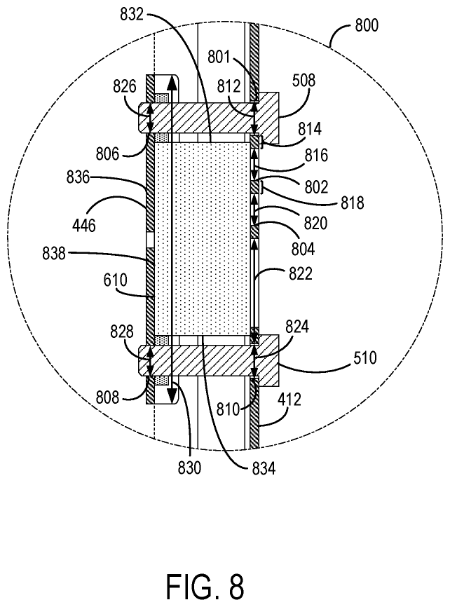

Referring to FIG. 8, an enlarged sectional view 800 of the portion encircled by inset 500 in FIG. 5 is shown. In particular, the enlarged sectional view 800 shows the vertical rail 412 and the rail mount 446 coupled to each other via mount fastener 508 and mount fastener 510. Further, FIG. 8 shows compartment rail 610 described above with reference FIG. 6 within the enlarged sectional view 800, where upper surface 832 of the compartment rail 610 may be referred to as a top side of the compartment rail 610 and is arranged toward an upper end of the vehicle including the cargo compartment containing the compartment rail 610 (e.g., upper surface 832 may face ceiling 214 shown by FIG. 2 and described above), and lower surface 834 of the compartment rail 610 may be referred to as a bottom side of the compartment rail 610 and is arranged toward a lower end of the vehicle (e.g., lower surface 834 may face compartment floor 216 shown by FIG. 2 and described above). As described above, the compartment rail 610 may be similar to, or the same as, the other compartment rails described herein, where the compartment rails are rails permanently installed to vehicle walls within a vehicle cargo compartment by fasteners inserted through the compartment rails into the vehicle walls, by welding the compartment rails to the vehicle walls, etc. In the view shown, the rail mount 446 and the vertical rail 412 are coupled to each other around the compartment rail 610 such that the compartment rail 610 is arranged between the rail mount 446 and the vertical rail 412. The configuration shown by FIG. 8 is the configuration in which the mobile storage assembly 400 is installed to the cargo compartment of the vehicle, with the position of the mobile storage assembly 400 within the cargo compartment maintained at least in part by the coupling of the rail mount 446 to the vertical rail 412 around the compartment rail 610. The rail mount 446 includes outer surface 836 configured to face a wall of the vehicle cargo compartment supporting the compartment rail 610. The wall may be similar to, or the same as, the compartment side walls described above (e.g., compartment side wall 118 shown by FIG. 1). The rail mount 446 additionally includes an inner surface 838 arranged opposite to the outer surface 836 and configured to face the vertical rail 412 and the compartment rail 610.

In the example shown, the mount fastener 508 extends through an opening 801 formed in the vertical rail 412 and is seated within an opening 806 formed within the rail mount 446. The mount fastener 508 extends through each of the opening 801 and the opening 806 without extending through the compartment rail 610. Similarly, the mount fastener 510 extends through opening 810 formed in the vertical rail 412 and is seated within opening 808 formed within the rail mount 446, and the mount fastener 510 does not extend through the compartment rail 610. In particular, in the example shown, the compartment rail 610 is arranged between the mount fastener 508 and the mount fastener 510 in the vertical direction (e.g., the direction between the compartment floor of the cargo compartment and the compartment ceiling of the cargo compartment).

Extending the mount fastener 508 through the opening 801 and extending the mount fastener 510 through the opening 810 of the vertical rail 412 is one example configuration in which the vertical rail 412 and the rail mount 446 may be coupled together. However, the vertical rail 412 includes a plurality of other openings shaped to receive the mount fastener 508 and the mount fastener 510, and during conditions in which the mobile storage assembly 400 is installed to the cargo compartment having a different configuration, the mount fastener 508 and the mount fastener 510 may be inserted through different openings of the vertical rail 412 in order to accommodate the particular configuration of the compartment rails of the cargo compartment.

For example, vehicles produced by different manufacturers may have different cargo compartment configurations, such as different spacing between compartment rails arranged within the cargo compartment of a vehicle. As one example, a first vehicle may have a larger, first spacing (e.g., length in the vertical direction) between adjacent compartment rails secured to a vehicle wall defining a cargo compartment of the first vehicle, and a second vehicle may have a smaller, second spacing between adjacent compartment rails secured to a vehicle wall defining a cargo compartment of the second vehicle. Additionally or alternatively, the first vehicle in the example described above may include compartment rails within the cargo compartment that have a larger, first length in the vertical direction, and the second vehicle in the example described above may include compartment rails within the cargo compartment that have a smaller, second length in the vertical direction. Although the seating of the mount fastener 508 within the opening 801 and the opening 806 and the seating of the mount fastener 510 within the opening 810 and the opening 808 may accommodate the arrangement of the compartment rail 610 between the mount fastener 508 and the mount fastener 510 during conditions in which the mobile storage assembly 400 is installed to the cargo compartment of the first vehicle, a different position of the rail mounts, such as rail mount 446, may be preferred during conditions in which the mobile storage assembly 400 is installed to the cargo compartment of the second vehicle.

Due to the different sizing and/or spacing of the compartment rails included by the second vehicle in the example described above, the coupling of the mount fastener 508 and the mount fastener 510 to the vertical rail 412 may be adjusted during installation of the mobile storage assembly 400 to the cargo compartment of the second vehicle relative to the coupling of the mount fastener 508 and the mount fastener 510 to the vertical rail 412 used during installation of the mobile storage assembly 400 to the cargo compartment of the first vehicle. For example, instead of seating the mount fastener 510 within the opening 810 of the vertical rail 412, the mount fastener 510 may instead be seated within opening 804 or the opening 802 of the vertical rail 412.

The opening 802 and the opening 804 are spaced apart from each other by a length 818. The opening 804 is spaced apart from the opening 810 by a length 822, and the opening is spaced apart from the opening 801 by a length 814. Each opening has a respective diameter which may be larger than a diameter of the mount fastener 508 and a diameter of the mount fastener 510. In particular, the opening 810 has a diameter 824, the opening 804 has a diameter 820, the opening 802 has a diameter 816, and the opening 801 has a diameter 812. In some examples, the diameter 824, the diameter 820, the diameter 816, and the diameter 812 may be equal (e.g., a same amount of length). Further, the opening 806 of the rail mount 446 has a diameter 826, and the opening 808 of the rail mount 446 has a diameter 828. In some examples, the diameter 826 may be equal to the diameter 820. Further, in some examples, the diameter 826 and the diameter 828 may be equal to each of the diameter 824, the diameter 820, the diameter 816, and the diameter 812. In some examples, a length 830 of the rail mount 446 may be equal to 5.5 inches.

During conditions in which the mount fastener 510 is seated within the opening 804, the mount fastener 510 may additionally seat within the opening 808 of the rail mount 446. However, instead of seating the mount fastener 508 within the opening 801, the mount fastener 508 may be seated within a different opening of the vertical rail 412, as described further below with reference to FIG. 10. In this configuration, the rail mount 446 may be arranged vertically higher along the vertical rail 412 relative to the configuration shown by FIG. 8, which may accommodate for installation of the mobile storage assembly 400 to the second vehicle having the smaller, second spacing of compartment rails as described above (e.g., smaller relative to the configuration of the compartment rails of the first vehicle). The various openings of the vertical rails may therefore provide a variety of different vertical positions at which the rail mounts, such as rail mount 446, may be coupled to the vertical rails, such as vertical rail 412, which may increase an ease of installation of the mobile storage assembly 400 to a variety of different cargo compartments having different compartment rail configurations. The particular arrangement of the openings of the vertical rail may be pre-determined at a time of manufacturing of the vertical rails and may be based on configurations of cargo compartments to which the mobile storage assembly 400 may be installed.

For example, turning momentarily to FIG. 10, opening 1000, opening 1002, and opening 1012 are shown, along with index 1014, index 1016, and index 1018. During conditions in which the mobile storage assembly 400 is to be installed to a cargo compartment of a vehicle with a pre-determined configuration of compartment rails, a user (e.g., installer) of the mobile storage assembly 400 may couple the rail mounts to the vertical rails, with compartment rails arranged between the rail mounts and the vertical rails, by inserting mount fasteners through the rails mounts and the vertical rails and without inserting the mount fasteners through the compartment rails. The selection of which openings of the vertical rails to insert the mount fasteners through may be based on the configuration of the compartment rails, with the indices (e.g., index 1014, index 1016, and index 1018) indicating which openings of the vertical rail receive the mount fasteners for particular cargo compartment configurations. For example, a first vehicle may include a first configuration of compartment rails, and installing the mobile storage assembly 400 to the cargo compartment of the first vehicle may include inserting a mount fastener through the opening indicated by the first index. However, a second vehicle may include a second configuration of compartment rails, and installing the mobile storage assembly 400 to the cargo compartment of the second vehicle may include inserting a mount fastener through the opening indicated by the second index. In this way, the indices may indicate to the user which openings of the vertical rail are to receive mount fasteners for a given cargo compartment configuration, which may increase an ease of installation of the mobile storage assembly 400 and increase a number of cargo compartments to which the mobile storage assembly 400 may be installed.

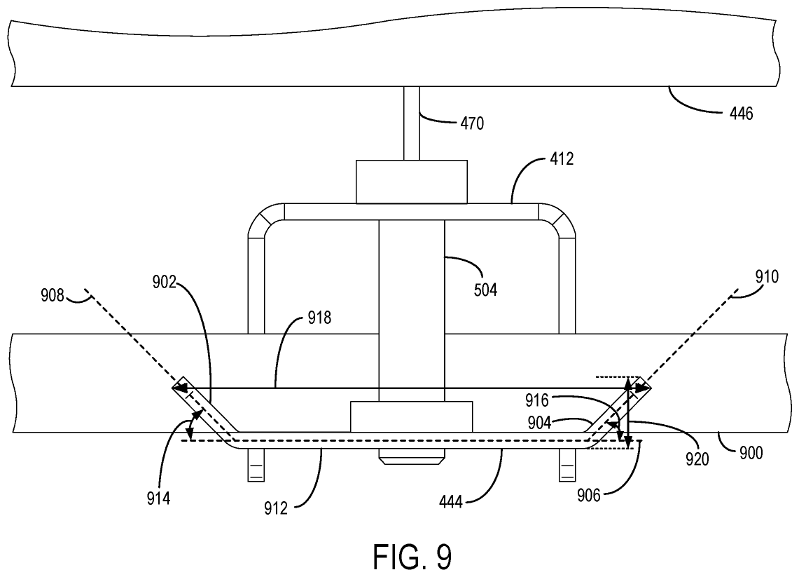

Referring to FIG. 9, a top view of the vertical rail 412 and the rail mount 444 is shown, with the vertical rail 412 and the rail mount 444 coupled together around a compartment rail 900 of a vehicle cargo compartment. Each rail mount of the mobile storage assembly 400 may be similar to, or the same as, the rail mount 444 shown by FIG. 9 and/or the rail mount 446 shown by FIG. 8. Further, the compartment rail 900 may be similar to the compartment rails described above (e.g., fixed to a vehicle wall in a horizontal orientation, where the vehicle wall defines a cargo compartment of the vehicle).

The rail mount 444 includes a rear portion 912, a first arm 902 extending from the rear portion 912 at a first angle 914, and a second arm 904 extending from the rear portion 912 at a second angle 916. In some examples, a magnitude of the first angle 914 may be equal to a magnitude of the second angle 916, with the first angle 914 being in a direction opposite to the second angle 916. The rear portion 912 is shown extending along axis 906, where the axis 906 may extend in a direction from a front of the vehicle to a rear of the vehicle during conditions in which the mobile storage assembly 400 is installed to the vehicle (e.g., the front of the vehicle may be a vehicle cab, such as cab 102 shown by FIG. 1, and the rear of the vehicle may be an opening of the cargo compartment, such as opening 138 shown by FIG. 1). The first arm 902 is shown extending along axis 908 and the second arm 904 is shown extending along axis 910, where the axis 908 is angled relative to the axis 906 by first angle 914, and the axis 910 is angled relative to the axis 906 by second angle 916. The axis 908 and the axis 910 extend in opposite directions.

In the configuration shown by the top view of FIG. 9, the first arm 902 and the second arm 904 are arranged vertically above the compartment rail 900 (where the vertical direction is the direction between the floor of the cargo compartment and the ceiling of the cargo compartment). The rail mount 444 includes a third arm 1020 and a fourth arm 1022 (shown by FIG. 10) each arranged vertically below the compartment rail 900. By coupling the rail mount 444 to the compartment rail 900 with the compartment rail 900 arranged between the rail mount 444 and the vertical rail 412, and additionally with the compartment rail 900 arranged vertically between the first arm 902 and the third arm 1020 (as indicated by length 1024 of the compartment rail 900 between the first arm 902 and the third arm 1020, shown by FIG. 10) and with the compartment rail 900 arranged vertically between the second arm 904 and the fourth arm 1022 (as indicated by length 1026 of the compartment rail 900 between the second arm 904 and the fourth arm 1022, shown by FIG. 10), the position of the rail mount 444 within the cargo compartment may be more easily maintained. In particular, during conditions in which load is applied to the rail mount 444 and the vertical rail 412 (e.g., due to a weight of cargo supported by the storage platform 447 coupled to the vertical rail 412), the first arm 902, second arm 904, third arm 1020, and fourth arm 1022 may increase an amount of surface area of the rail mount 444 in direct contact with the compartment rail 900 and reduce a likelihood of undesired vibration or other movement of the rail mount 444 relative to the compartment rail 900. As a result, a stability and/or load capacity of the mobile storage assembly 400 may be increased. Although the rail mount 444 is described above, each rail mount of the mobile storage assembly 400 may have a similar configuration. The arms of each rail mount may be referred to herein as angled arms.

In some examples, a width 918 of the rail mount 444 may be equal to 3.69 inches. In some examples, a depth 920 of the rail mount 444 may be equal to 0.54 inches.

Referring to FIG. 10, a front view of the vertical rail 412 is shown. The vertical rail 412 includes a plurality of slots arranged along a vertical length 1028 of the vertical rail 412, such as slot 1004, slot 1006, slot 1008, and slot 1010. The slots are shaped to receive support braces of the mobile storage assembly 400, such as the support braces described above with reference to FIG. 4. The plurality of slots may provide mounting of the support braces to the vertical rail 412 at a plurality of different vertical positions, which may increase an ease of storage of cargo of different sizes via the mobile storage assembly 400. For example, during conditions in which storage of larger cargo is preferred, the support braces may be coupled to slots of the vertical rail 412 that result in increased spacing between the support braces coupled to the vertical rail 412 in the vertical direction, which may provide for storage of larger cargo by increasing the spacing between the storage platforms supported by the vertical rail 412. As another example, during conditions in which storage of smaller cargo is preferred, the support braces may be coupled to slots of the vertical rail 412 that result in a higher vertical position of the support braces, which may increase an ease of access to the cargo by increasing the vertical position of the storage platforms supported by the vertical rail 412. Other examples are possible.

In some examples, a length 1030 between an upper end of the vertical rail 412 and a center of the opening configured to receive the mount fastener 504 may be equal to 3.29 inches. A diameter 1034 of the opening configured to receive the mount fastener 504 may be equal to 0.56 inches. A length 1032 between a center of the opening configured to receive the mount fastener 504 and the slot configured to receive the mount fastener 506 may be equal to 2.78 inches. A length 1036 of the slot configured to receive the mount fastener 506 may be equal to 1.94 inches. A length 1038 between the slot configured to receive the mount fastener 506 and opening 1002 may be 2.12 inches. A length 1040 between the opening 1002 and the adjacent slot 1004 may be equal to 1.81 inches. A length 1042 of the slot 1004 may be equal to 1.5 inches. The slot 1004, slot 1006, slot 1008, and slot 1010 be included within a set of slots each having an equal size (e.g., profile), and a length 1044 between adjacent slots of the set of slots may be 1 inch. A length 1046 of opening 1012 may be equal to 1.32 inches. A length 1048 between a center of the opening configured to receive the mount fastener 508 and a center of the opening 802 may be equal to 0.76 inches. A length 1050 between the center of the opening 802 and a center of the opening 804 may be equal to 0.76 inches. A length 1052 between the center of the opening 804 and a center of the opening configured to receive the mount fastener 510 may be equal to 2.54 inches.

Referring to FIG. 11, a side sectional view of the vertical rail 412 is shown, with support brace 470 coupled to the vertical rail 412. In particular, the support brace 470 is shown seated within the slot 1004 and the slot 1006 of the vertical rail 412, with an upper protrusion 1100 of the support brace 470 inserted through the slot 1004 and with a lower protrusion 1102 of the support brace 470 inserted through the slot 1006. The upper protrusion 1100 includes a hooked portion 1104 that may seat in direct contact against a rear surface 1110 of the vertical rail 412, where the slots of the vertical rail 412 are formed by the rear surface 1110 and a forward surface 1112 of the vertical rail 412. By seating directly against the rear surface 1110, the hooked portion 1104 of the upper protrusion 1100 of the support brace 470 may reduce a likelihood of undesired movement of the support brace 470 and may transfer load applied to the storage platform 447 (e.g., a weight of cargo supported by the storage platform 447) to the vertical rail 412.

The lower protrusion 1102 of the support brace 470 may seat directly against the forward surface 1112 of the vertical rail 412 via a first stepped edge 1106 and a second stepped edge 1108. The direct contact of the hooked portion 1104 against the rear surface 1110 in combination with the direct contact of the first stepped edge 1106 and a second stepped edge 1108 against the forward surface 1112 may maintain the position of the support brace 470 relative to the vertical rail 412 and increase a load capacity of the storage platform 447 via increased load transfer from the storage platform 447 to the vertical rail 412 through the support brace 470. As a result, a stability and load capacity of the mobile storage assembly 400 may be increased. Although the coupling of the support brace 470 to the vertical rail 412 is described above, each support brace of the mobile storage assembly 400 may have a similar configuration and may couple to vertical rails of the mobile storage assembly 400 in a similar way, in some examples.

Referring to FIG. 12, a perspective view a portion of a mobile storage assembly 1200 is shown. In particular, FIG. 12 shows a pair of vertical rails of the mobile storage assembly 1200, with the vertical rails coupled to compartment rails of a cargo compartment of a vehicle. The vehicle may be similar to, or the same as, the vehicle 100 shown by FIG. 1 and described above, in some examples. Further, in some examples, the vertical rails may be similar to, or the same as, the vertical rails included by the mobile storage assembly 400 shown by FIG. 4 and described above.

In the embodiment shown, each vertical rail is coupled to the compartment rails of the vehicle cargo compartment by a plurality of rail mounts. FIG. 12 shows a first compartment rail 1202, a second compartment rail 1204, and a third compartment rail 1206, with each compartment rail being parallel with each other compartment rail. The first compartment rail 1202, the second compartment rail 1204, and the third compartment rail 1206 may each be fixed to a wall defining the cargo compartment of the vehicle, which may be similar to, or the same as, the compartment side wall 118 shown by FIG. 1 and described above.

A first vertical rail 1214 of the mobile storage assembly 1200 is shown coupled to the second compartment rail 1204 by a first rail mount 1226 and a second rail mount 1228. The first vertical rail 1214 is additionally shown coupled to the third compartment rail 1206 via a third rail mount 1230 and a fourth rail mount 1232. A second vertical rail 1216 arranged parallel to the first vertical rail 1214 is shown coupled to the second compartment rail 1204 by a fifth rail mount 1234 and a sixth rail mount 1236. The second vertical rail 1216 is additionally shown coupled to the third compartment rail 1206 via a seventh rail mount 1238 and an eighth rail mount 1240. In some examples, the first vertical rail 1214 and/or the second vertical rail 1216 may additionally be coupled to the first compartment rail 1202 via respective rail mounts similar to the rail mounts coupling the first vertical rail 1214 and the second vertical rail 1216 to the second compartment rail 1204 and the third compartment rail 1206.

Each of the compartment rails of the vehicle cargo compartment includes a plurality of slots (e.g., openings), and the rail mounts of the mobile storage assembly 1200 are shaped to seat within the slots of the compartment rails to secure the position of the vertical rails relative to the compartment rails. For example, the first compartment rail 1202 includes a plurality of slots 1208, the second compartment rail 1204 includes a plurality of slots 1210, and the third compartment rail 1206 includes a plurality of slots 1212. The slots 1208, the slots 1210, and the slots 1212 may each have a same shape (e.g., a same width, height, depth, and/or profile). As described further below, the rail mounts may be fixed to the vertical rails and may seat within the slots in order to maintain the upright position of the vertical rails during conditions in which the mobile storage assembly 1200 is installed to the vehicle cargo compartment.

In some embodiments, the mobile storage assembly 1200 may include a spacing guide 1244. The spacing guide 1244 may include features at opposing ends shaped to seat within slots of each vertical rail. For example, the first vertical rail 1214 is shown including a plurality of slots 1218, and the second vertical rail 1216 is shown including a plurality of slots 1220. A first end 1246 of the spacing guide 1244 may include a feature (e.g., a protrusion) shaped to seat within the slots 1218 of the first vertical rail 1214, and an opposing, second end 1248 of the spacing guide 1244 may include a similar feature shaped to seat within the slots 1220 of the second vertical rail 1216.

A user of the mobile storage assembly 1200 (e.g., an installer) may couple the spacing guide 1244 to each of the first vertical rail 1214 and the second vertical rail 1216 during installation of the first vertical rail 1214 and the second vertical rail 1216 to the vehicle cargo compartment in order to provide a pre-determine spacing between the first vertical rail 1214 and the second vertical rail 1216. For example, the mobile storage assembly 1200 may include a plurality of shelves which may be similar to, or the same as, the shelves described above with reference to FIG. 4. Each shelf may have a pre-determined length, and in some examples, a length of each shelf may be equal to a length of each other shelf. As one example, a length of each shelf may be 48 inches, where the length is measured in a direction parallel with the compartment rails (e.g., the direction from the first end 1246 of the spacing guide 1244 to the second end 1248 of the spacing guide 1244, as shown by FIG. 12). By coupling the spacing guide 1244 to the first vertical rail 1214 and the second vertical rail 1216 during installation of the mobile storage assembly 1200 to the vehicle cargo compartment, a spacing between adjacent vertical rails, such as a spacing between a center of the first vertical rail 1214 and a center of the second vertical rail 1216, may be controlled by the user more easily and with greater precision. As a result, an ease of assembly (e.g., installation) of the mobile storage assembly 1200 may be increased.

Referring to FIG. 13, a perspective view of the spacing guide 1244 is shown. The view of the spacing guide 1244 shown by FIG. 13 is opposite to the view shown by FIG. 12. In particular, FIG. 13 shows an inner surface 1310 of the spacing guide 1244, and during conditions in which the spacing guide 1244 is coupled to the first vertical rail 1214 and the second vertical rail 1216 shown by FIG. 12, the inner surface 1310 faces the vehicle cargo compartment wall to which the compartment rails (e.g., first compartment rail 1202, second compartment rail 1204, and third compartment rail 1206) are fixed.

As shown by FIG. 13, the spacing guide 1244 includes a first protrusion 1300 arranged at the first end 1246 of the spacing guide 1244. The spacing guide 1244 additionally includes a second protrusion 1302 arranged at the second end 1248 of the spacing guide 1244. The first protrusion 1300 and the second protrusion 1302 are each shaped to seat within slots of the vertical rails in order to couple the spacing guide 1244 to the vertical rails. For example, the first protrusion 1300 may seat within one of the slots 1218 of the first vertical rail 1214 shown by FIG. 12, and the second protrusion 1302 may seat within one of the slots 1220 of the second vertical rail 1216 shown by FIG. 12. A length 1308 between the first protrusion 1300 and the second protrusion 1302 may be equal to a pre-determined length, where the pre-determined length may be a length of shelves of the mobile storage assembly 1200 as described above. During conditions in which the spacing guide 1244 is coupled to the vertical rails, an upper end 1304 of the spacing guide 1244 may be arranged at a higher vertical position within the vehicle cargo compartment (e.g., toward upper and 1222 of the vertical rails shown by FIG. 12, opposite to the lower end 1224 of the vertical rails) than a lower end 1306 of the spacing guide 1244. In some embodiments, the first protrusion 1300 and/or the second protrusion 1302 may include hooks, slots, or other features shaped to engage with the slots of the vertical rails to maintain the engagement of the spacing guide 1244 with the vertical rails during the installation of the mobile storage assembly 1200.

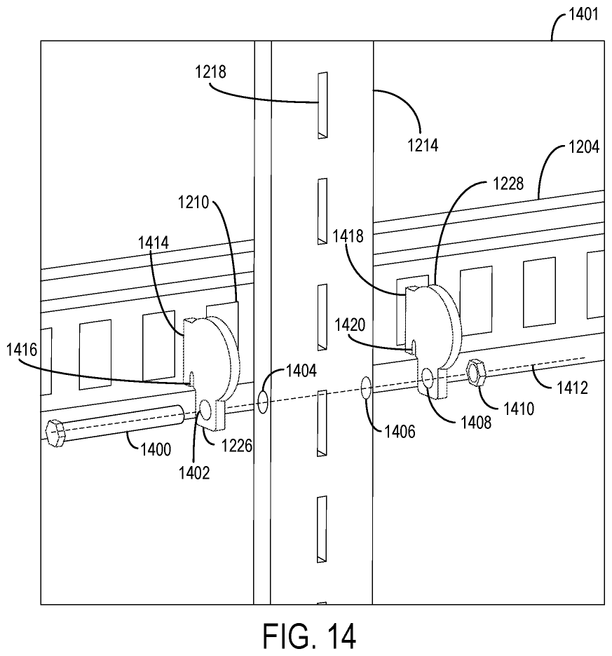

Referring to FIG. 14, an enlargement 1401 of inset 1242 of FIG. 12 is shown. The enlargement 1401 shows a portion of the first vertical rail 1214 and a portion of the second compartment rail 1204, with the first rail mount 1226 and the second rail mount 1228 in a disengaged configuration. In particular, the first rail mount 1226 and the second rail mount 1228 are shown unseated from the second compartment rail 1204 and are decoupled from the first vertical rail 1214. The first rail mount 1226 and the second rail mount 1228 may be coupled to the first vertical rail 1214 along axis 1412, where the axis 1412 is an axis of assembly extending through a first side opening 1404 and a second side opening 1406 of the first vertical rail 1214. The first side opening 1404 is arranged coaxially relative to the second side opening 1406 along the axis 1412. Further, FIG. 14 shows a fastener 1400 shaped to seat within each of the first side opening 1404 and the second side opening 1406, and a retaining feature 1410 (e.g., a nut) shaped to couple to the fastener 1400. The fastener 1400 may be referred to herein as a shaft.

Coupling the first rail mount 1226 and the second rail mount 1228 to the first vertical rail 1214 may include positioning the first rail mount 1226 against the first vertical rail 1214 with an opening 1402 of the first rail mount 1226 aligned with the first side opening 1404 of the first vertical rail 1214, and positioning the second rail mount 1228 against the first vertical rail 1214 at a location opposite to the first rail mount 1226 and with an opening 1408 of the second rail mount 1228 aligned with the second side opening 1406 of the first vertical rail 1214. With the first rail mount 1226 and the second rail mount 1228 each positioned against the first vertical rail 1214 at opposing sides of the first vertical rail 1214, the fastener 1400 may be inserted through each of the opening 1402 of the first rail mount 1226, the first side opening 1404 of the first vertical rail 1214, the second side opening 1406 of the first vertical rail 1214, and the opening 1408 of the second rail mount 1228. The position of the fastener 1400 within each of the openings may be maintained by engagement of the retaining feature 1410 with the fastener 1400. In this configuration, the user of the mobile storage assembly 1200 may couple the first vertical rail 1214 to the vehicle cargo compartment rails at a desired position within the vehicle cargo apartment by seating the first rail mount 1226 and the second rail mount 1228 within corresponding slots 1210 of the second compartment rail 1204, as shown by FIG. 12.

In the embodiment shown, the first rail mount 1226 includes a protrusion 1414 forming a partial slot 1416 (e.g., a hook feature), and during conditions in which the first rail mount 1226 is seated within one of the slots 1210 of the second compartment rail 1204, a portion of the second compartment rail 1204 defining the slot receiving the first rail mount 1226 may engage with the partial slot 1416 of the first rail mount 1226 to maintain the position of the first rail mount 1226 relative to the second compartment rail 1204. Similarly, the second rail mount 1228 includes a protrusion 1418 forming a partial slot 1420, and the protrusion 1418 and the partial slot 1420 may be similar to, or have a same shape as, the protrusion 1414 and the partial slot 1416, respectively, of the first rail mount 1226. The partial slot 1420 of the second rail mount 1228 may engage with the corresponding slot of the second compartment rail 1204 in a way similar to the engagement of the first rail mount 1226 with the corresponding slot of the second compartment rail 1204.

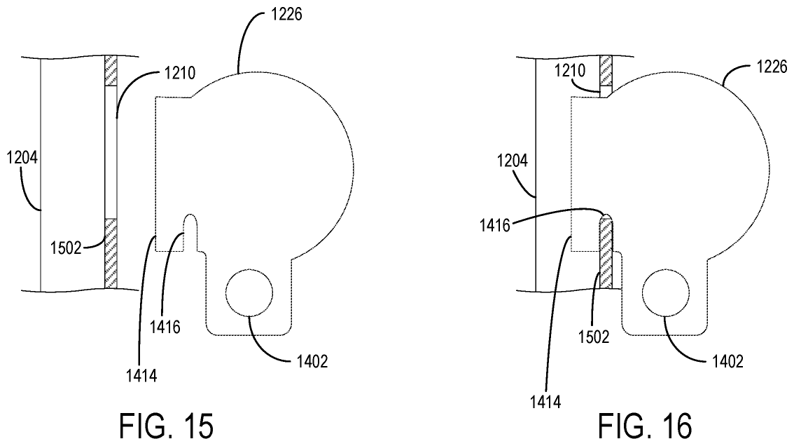

For example, referring to FIG. 15, the first rail mount 1226 is shown disengaged (e.g., decoupled) from the second compartment rail 1204. In this configuration, the partial slot 1416 formed by the protrusion 1414 of the first rail mount 1226 is not engaged with the surfaces of the second compartment rail 1204 (e.g., the surfaces of the first rail mount 1226 defining the partial slot 1416 are not in direct face-sharing contact with the surfaces of the second compartment rail 1204).

However, the first rail mount 1226 may be seated against the second compartment rail 1204 with the partial slot 1416 of the first rail mount 1226 engaged with surfaces of the second compartment rail 1204, as shown by FIG. 16. In the view shown by FIG. 16, a wall 1502 of the second compartment rail 1204 defining the slots 1210 of the second compartment rail 1204 is in direct, face-sharing contact with the surfaces of the first rail mount 1226 defining the partial slot 1416. The first rail mount 1226 is inserted through the slot of the second compartment rail 1204, with the partial slot 1416 fitting around the wall 1502. In particular, the first rail mount 1226 is seated such that a portion of the wall 1502 is arranged between opposing ends of the partial slot 1416.

In this configuration, the wall 1502 of the second compartment rail 1204 engages directly with the surfaces of the first rail mount 1226 forming the partial slot 1416 to maintain the position of the first rail mount 1226 relative to the second compartment rail 1204. In particular, a vertical load applied to the first rail mount 1226 due to a weight of cargo or other items supported by the mobile storage assembly 1200 may press the first rail mount 1226 against the wall 1502 of the second compartment rail 1204, with the engagement of the partial slot 1416 of the first rail mount 1226 with the wall 1502 resisting a movement of the first rail mount 1226 in a downward vertical direction. As a result, the position of the first rail mount 1226 relative to the second compartment rail 1204 may be maintained, and during conditions in which the first vertical rail 1214 is coupled to the first rail mount 1226 as described above, the position of the first vertical rail 1214 relative to the second compartment rail 1204 may also be maintained.

Although the first rail mount 1226 is described above, each rail mount of the mobile storage assembly 1200 (e.g., second rail mount 1228, third rail mount 1230, fourth rail mount 1232, fifth rail mount 1234, etc., shown by FIG. 12) may couple to the vehicle cargo compartment rails in a similar way.

Referring to FIG. 17, a method 1700 for assembly of a mobile storage assembly within a vehicle cargo compartment is shown. The mobile storage assembly may be similar to, or the same as, the mobile storage assembly 400 shown by FIG. 4 and described above, and/or the mobile storage assembly 1200 described above with reference to FIG. 12. The vehicle cargo compartment may be similar to, or the same as, the vehicle cargo compartment 104 shown by FIG. 1 and described above, and/or the vehicle cargo compartment 204 shown by FIG. 2 and described above. Further, the components of the mobile storage assembly and/or the vehicle cargo compartment may be similar to, or the same as, the components labeled similarly and described above.

At step 1702, the method includes coupling a rail mount to a compartment rail of a vehicle cargo compartment and coupling a vertical rail to the rail mount, without modifying the structure of the compartment rail. The rail mount may be similar to, or the same as, the rail mount 446 described above with reference to FIG. 4, and/or the rail mount 1226 described above with reference to FIG. 12. The vertical rail may be similar to, or the same as, the vertical rail 412 described above with reference to FIG. 4, and/or the vertical rail 1214 described above with reference to FIG. 12.

The method at step 1702 may include, at step 1704, arranging the rail mount between the compartment rail and a vehicle cargo compartment wall. The rail mount may fit within a clearance formed between the compartment rail and the vehicle cargo compartment wall, such as the clearance 272 described above with reference to FIG. 3.

The method at step 1704 may include, at step 1706, inserting a single fastener through the vertical rail and partially threading the fastener into the rail mount. For example, the single fastener may be inserted through an opening of the vertical rail and partially threaded into the rail mount such that the rail mount may pivot relative to the vertical rail. The pivoting of the rail mount may provide for increased ease of positioning of the rail mount between the compartment rail and the vehicle cargo compartment wall. After positioning the rail mount as desired, the single fastener may be fully threaded into the rail mount, and one or more additional fasteners may be inserted through the vertical rail and threaded into the rail mount to increase a securement of the rail mount to the vertical rail. Each fastener inserted through the vertical rail and into the rail mount bypasses the compartment rail, such that the compartment rail is not modified (e.g., no holes are formed in the compartment rail) by the coupling of the vertical rail and the rail mount.

The method at step 1702 may include, at step 1708, seating the rail mount within slots of the cargo compartment rail. The slots of the cargo compartment rail may be similar to, or the same as, the slots 1210 of compartment rail 1204 described above. The rail mount may include protrusions shaped to seat within the slots, such as the protrusion 1414 of rail mount 1226 described above with reference to FIG. 14.

The method at step 1702 may include, at step 1709, setting the vertical rail horizontal position via a removable spacing guide. The horizontal position may refer to a position within the vehicle cargo compartment (e.g., a position between compartment end wall 122 and opening 138 described above with reference to FIG. 1) and a relative spacing between adjacent vertical rails of the mobile storage assembly. The spacing guide may be similar to, or the same as, the spacing guide 1244 described above with reference to FIG. 12.

The method continues from step 1702 to step 1710 where the method includes coupling a storage platform support brace to the vertical rail. The storage platform support brace may seat within slots of the vertical rail, such slot 1004, slot 1006, slot 1008, and/or slot 1010 described above with reference to FIG. 10, and/or slots 1218 described above with reference to FIG. 12. The support brace may be similar to, or the same as, the support brace 470 described above with reference to FIG. 4.

The method continues from step 1710 to step 1712 where the method includes coupling the storage platform to the support brace. Coupling the storage platform to the support brace may include inserting one or more fasteners (e.g., bolts) through each of the storage platform and the support brace.

The method may continue from step 1712 to step 1714 where the method includes coupling an end stop and/or an end container to the storage platform. The end stop may be similar to, or the same as, the end stop 405 described above with reference to FIG. 4, and the end container may be similar to, or the same as, the end container 401 described above with reference to FIG. 4. Coupling the end stop to the storage platform may include inserting fasteners through each of the end stop and the storage platform, in some examples. Coupling the end container to the storage platform may include inserting fasteners through each of the end container and the storage platform, in some examples.

Referring to FIG. 18, a method 1800 for relocating a mobile storage assembly from a first vehicle cargo compartment to a second vehicle cargo compartment is shown. The mobile storage assembly may be similar to, or the same as, the mobile storage assembly 400 shown by FIG. 4 and described above, and/or the mobile storage assembly 1200 described above with reference to FIG. 12. The first vehicle cargo compartment and/or second vehicle cargo compartment may be similar to, or the same as, the vehicle cargo compartment 104 shown by FIG. 1 and described above, and/or the vehicle cargo compartment 204 shown by FIG. 2 and described above. Further, the components of the mobile storage assembly and/or the vehicle cargo compartment may be similar to, or the same as, the components labeled similarly and described above. In some examples, the method 1700 shown by FIG. 17 and described above may be included with the method 1800 shown by FIG. 18 and described below. For example, installation of the mobile storage assembly to the first vehicle cargo compartment described herein with reference to method 1800 may be performed according to the method 1700 described above.

The method at step 1802 includes installing a mobile storage assembly to a first vehicle cargo compartment without modifying compartment rails of the first vehicle cargo compartment. In particular, the mobile storage assembly is installed to the first vehicle cargo compartment without drilling, cutting, or otherwise altering the structure (e.g., shape) of the compartment rails of the first cargo compartment.

The method at step 1802 includes, at step 1804, aligning rail mounts of the mobile storage assembly with a first set of openings of vertical rails of the mobile storage assembly. The first set of openings of the vertical rails may be openings having a size and/or spacing resulting in a desired spacing and/or position of the vertical rails within the first vehicle cargo compartment during conditions in which the vertical rails are fixed to compartment rails of the vehicle cargo compartment by the rails mounts. For example, the first set of openings may include opening 802 and opening 1012 shown by FIG. 10 and described above, and may not include opening 804 shown by FIG. 10 and described above.

The method at step 1802 includes, at step 1806, coupling the rail mounts to the vertical rails and compartment rails of the first vehicle cargo compartment by inserting fasteners through the openings of the first set of openings, bypassing the fasteners around the compartment rails, and seating the fasteners within the rail mounts. Bypassing the fasteners around the compartment rails includes not inserting the fasteners through the compartment rails. In particular, no portion of the fasteners inserts into the compartment rails, passes through the compartment rails, etc.

The method at step 1802 may include, at step 1808, coupling support brackets and storage platforms to the vertical rails. Coupling the support brackets and storage platforms to the vertical rails may include seating the support brackets within slots of the vertical rails, and coupling the storage platforms to the support brackets (e.g., via fasteners, such as bolts, clips, etc.).

The method continues from step 1802 to step 1810 where the method includes determining whether relocation of the mobile storage assembly is desired. Relocation of the mobile storage assembly may be desired by a user of the mobile storage assembly during conditions in which the user transitions from operating the vehicle including the first vehicle cargo compartment to operating a vehicle including a second vehicle cargo compartment, for example, and relocation of the mobile storage assembly from the first vehicle cargo compartment to the second vehicle cargo compartment may increase a cargo storage capacity and/or ease of access of the second vehicle cargo compartment.

If relocation of the mobile storage assembly is not desired at step 1810, the method continues from step 1810 to step 1826 where the method includes maintaining mobile storage assembly conditions. Maintaining conditions may include maintaining the mobile storage assembly installed to the first vehicle cargo compartment.

However, if relocation of the mobile storage assembly is desired at step 1810, the method continues from step 1810 to step 1812 where the method includes removing the mobile storage assembly from the first vehicle cargo compartment.

The method at step 1812 includes, at step 1814, decoupling the rail mounts and the vertical rails from the compartment rails. Decoupling the rail mounts and the vertical rails from the compartment rails may be performed by reversing the installation of the mobile storage assembly (e.g., decoupling the fasteners to separate the rail mounts from the vertical rails).

The method at step 1812 may include, at step 1816, decoupling the support brackets and storage platforms from the vertical rails.

The method continues from step 1812 to step 1818 where the method includes installing the mobile storage assembly to a second vehicle cargo compartment without modifying compartment rails of the second vehicle cargo compartment.

The method at step 1818 includes, at step 1820, aligning rail mounts of the mobile storage assembly with a second set of openings of the vertical rails of the mobile storage assembly. The second set of openings may be different than the first set of openings. For example, the second set of openings may include opening 804 described above with reference to FIG. 10, and may not include the opening 802 of the first set. However, in some examples, one or more openings may be included by both of the first set of openings and the second set of openings.

The method at step 1818 includes, at step 1822, coupling the rail mounts to the vertical rails and compartment rails of the second vehicle cargo compartment by inserting fasteners through the openings of the second set of openings, bypassing the fasteners around the compartment rails, and seating the fasteners within the rail mounts.

The method at step 1818 may include, at step 1824, coupling support brackets and storage platforms to the vertical rails.

FIGS. 1-16 are shown approximately to scale, although other relative dimensions may be used, if desired.

FIGS. 1-16 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The disclosure also provides support for a mobile storage assembly for a vehicle cargo compartment comprising a first stationary component and a second stationary component, the mobile storage assembly comprising: a first rail including a first opening on a first end and a second opening on a second end, a first rail mount and a second rail mount including a third opening and a fourth opening respectively, and a first shaft passing through the first opening of the first rail positioned on a first side of the first stationary component and the third opening of the first rail mount positioned on a second side of the first stationary component to couple the first rail mount and the first rail while bypassing each of the first stationary component and the second stationary component, a second shaft passing through the second opening of the first rail positioned on the first side of the second stationary component and the fourth opening of the second rail mount positioned on the second side of the second stationary component to couple the second rail mount and the first rail while bypassing each of the first stationary component and the second stationary component, a first shelf bracket coupled to the first rail and a second shelf bracket coupled to a second rail, and a shelf positioned on the first shelf bracket and the second shelf bracket. In a first example of the system, the first rail mount and the second rail mount each include respective angled arms shaped to engage with the first stationary component. In a second example of the system, optionally including the first example, the first rail mount and the second rail mount each include a respective outer surface configured to face a wall of the vehicle cargo compartment supporting the first stationary component and the second stationary component while the first rail mount and the second rail mount are coupled to the first rail, and a respective inner surface opposite to the outer surface configured to face the first rail and the first stationary component. In a third example of the system, optionally including one or both of the first and second examples, the first rail mount and the second rail mount are each shaped to seat within a clearance between the first stationary component and a wall supporting the first stationary component. In a fourth example of the system, optionally including one or more or each of the first through third examples, the first rail mount and the second rail mount each engage directly with the first stationary component while coupled to the first rail, with the first stationary component arranged between the first rail and the first rail mount and between the first rail and the second rail mount. In a fifth example of the system, optionally including one or more or each of the first through fourth examples, the engagement of the first rail mount and the second rail mount with the first stationary component fixes the first rail to the first stationary component without any portion of the mobile storage assembly extending into the first stationary component. In a sixth example of the system, optionally including one or more or each of the first through fifth examples, the third opening is coaxially aligned with the first opening while the first rail mount is coupled to the first rail.

The disclosure also provides support for a method for a mobile storage assembly for a vehicle cargo compartment, comprising: coupling a rail mount to a first rail by inserting a shaft through each of an opening of the first rail and an opening of the rail mount while bypassing the shaft around a stationary component of the vehicle cargo compartment, with the first rail positioned on a first side of the stationary component and the rail mount positioned on a second side of the stationary component, inserting a first shelf bracket into the first rail and a second shelf bracket into a second rail, and positioning a shelf on the first shelf bracket and the second shelf bracket. In a first example of the method, the rail mount is positioned directly against the second side of the stationary component. In a second example of the method, optionally including the first example, the first rail is positioned directly against the first side of the stationary component and the shaft compresses the rail mount and the first rail against the stationary component. In a third example of the method, optionally including one or both of the first and second examples, the shaft traverses the stationary component on a third side of the stationary component, and the third side is a top side. In a fourth example of the method, optionally including one or more or each of the first through third examples, the shaft is a first shaft, and a second shaft traverses the stationary component on a fourth side of the stationary component to couple the first rail and the rail mount, and the fourth side is a bottom side.

The disclosure also provides support for a method, comprising: installing a mobile storage assembly to a first vehicle cargo compartment without modifying compartment rails of the first vehicle cargo compartment by: aligning rail mounts of the mobile storage assembly with a first set of openings of vertical rails of the mobile storage assembly, and coupling the rail mounts to the vertical rails and the compartment rails by inserting fasteners through the first set of openings, bypassing the fasteners around the compartment rails, and seating the fasteners within the rail mounts. In a first example of the method, aligning the rail mounts of the mobile storage assembly with the first set of openings of the vertical rails includes arranging the rail mounts between the compartment rails and a vehicle cargo compartment wall supporting the compartment rails. In a second example of the method, optionally including the first example, aligning the rail mounts of the mobile storage assembly with the first set of openings of the vertical rails includes seating the rail mounts within slots of the compartment rails. In a third example of the method, optionally including one or both of the first and second examples, the method further comprises: setting a horizontal position of the vertical rails relative to the compartment rails via a spacing guide shaped to couple to the vertical rails. In a fourth example of the method, optionally including one or more or each of the first through third examples, the spacing guide includes a first protrusion at a first end and a second protrusion at an opposing, second end, where the first protrusion and the second protrusion are shaped to seat within slots of the vertical rails, and a length between the first protrusion and the second protrusion is equal to a length of a shelf to be supported by the vertical rails. In a fifth example of the method, optionally including one or more or each of the first through fourth examples, the method further comprises: coupling support brackets to the vertical rails and coupling a shelf to the support brackets. In a sixth example of the method, optionally including one or more or each of the first through fifth examples, the method further comprises: coupling an end stop and/or an end container to the shelf. In a seventh example of the method, optionally including one or more or each of the first through sixth examples, the method further comprises: removing the mobile storage assembly from the first vehicle cargo compartment, and installing the mobile storage assembly to a second vehicle cargo compartment without modifying compartment rails of the second vehicle cargo compartment by: aligning the rail mounts with a second set of openings of the vertical rails, and coupling the rail mounts to the vertical rails and the compartment rails of the second vehicle cargo compartment by inserting fasteners through the openings of the second set of openings, bypassing the fasteners around the compartment rails of the second vehicle cargo compartment, and seating the fasteners within the rail mounts.

It will be appreciated that the configurations and routines disclosed herein are exemplary in nature, and that these specific embodiments are not to be considered in a limiting sense, because numerous variations are possible. For example, the above technology can be applied to other vehicle types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A mobile storage assembly for a vehicle cargo compartment comprising a first stationary component and a second stationary component, the mobile storage assembly comprising:
a first rail including a first opening on a first end and a second opening on a second end;
a first rail mount and a second rail mount including a third opening and a fourth opening respectively; and
a first shaft passing through the first opening of the first rail positioned on a first side of the first stationary component and the third opening of the first rail mount positioned on a second side of the first stationary component to couple the first rail mount and the first rail while bypassing each of the first stationary component and the second stationary component;
a second shaft passing through the second opening of the first rail positioned on the first side of the second stationary component and the fourth opening of the second rail mount positioned on the second side of the second stationary component to couple the second rail mount and the first rail while bypassing each of the first stationary component and the second stationary component;
a first shelf bracket coupled to the first rail and a second shelf bracket coupled to a second rail; and
a shelf positioned on the first shelf bracket and the second shelf bracket.

2. The mobile storage assembly of claim 1, wherein the first rail mount and the second rail mount each include respective angled arms shaped to engage with the first stationary component.

3. The mobile storage assembly of claim 1, wherein the first rail mount and the second rail mount each include a respective outer surface configured to face a wall of the vehicle cargo compartment supporting the first stationary component and the second stationary component while the first rail mount and the second rail mount are coupled to the first rail, and a respective inner surface opposite to the outer surface configured to face the first rail and the first stationary component.

4. The mobile storage assembly of claim 1, wherein the first rail mount and the second rail mount are each shaped to seat within a clearance between the first stationary component and a wall supporting the first stationary component.

5. The mobile storage assembly of claim 1, wherein the first rail mount and the second rail mount each engage directly with the first stationary component while coupled to the first rail, with the first stationary component arranged between the first rail and the first rail mount and between the first rail and the second rail mount.

6. The mobile storage assembly of claim 5, wherein the engagement of the first rail mount and the second rail mount with the first stationary component fixes the first rail to the first stationary component without any portion of the mobile storage assembly extending into the first stationary component.

7. The mobile storage assembly of claim 1, wherein the third opening is coaxially aligned with the first opening while the first rail mount is coupled to the first rail.

8. A method for a mobile storage assembly for a vehicle cargo compartment, comprising:
coupling a rail mount to a first rail by inserting a shaft through each of an opening of the first rail and an opening of the rail mount while bypassing the shaft around a stationary component of the vehicle cargo compartment, with the first rail positioned on a first side of the stationary component and the rail mount positioned on a second side of the stationary component;
inserting a first shelf bracket into the first rail and a second shelf bracket into a second rail; and
positioning a shelf on the first shelf bracket and the second shelf bracket.

9. The method of claim 8, wherein the rail mount is positioned directly against the second side of the stationary component.

10. The method of claim 8, wherein the first rail is positioned directly against the first side of the stationary component and the shaft compresses the rail mount and the first rail against the stationary component.

11. The method of claim 8, wherein the shaft traverses the stationary component on a third side of the stationary component, and the third side is a top side.

12. The method of claim 8, wherein the shaft is a first shaft, and a second shaft traverses the stationary component on a fourth side of the stationary component to couple the first rail and the rail mount, and the fourth side is a bottom side.

13. A method, comprising:
installing a mobile storage assembly to a first vehicle cargo compartment without modifying compartment rails of the first vehicle cargo compartment by:
aligning rail mounts of the mobile storage assembly with a first set of openings of vertical rails of the mobile storage assembly; and
coupling the rail mounts to the vertical rails and the compartment rails by inserting fasteners through the first set of openings, bypassing the fasteners around the compartment rails, and seating the fasteners within the rail mounts.

14. The method of claim 13, wherein aligning the rail mounts of the mobile storage assembly with the first set of openings of the vertical rails includes arranging the rail mounts between the compartment rails and a vehicle cargo compartment wall supporting the compartment rails.

15. The method of claim 13, wherein aligning the rail mounts of the mobile storage assembly with the first set of openings of the vertical rails includes seating the rail mounts within slots of the compartment rails.

16. The method of claim 13, further comprising setting a horizontal position of the vertical rails relative to the compartment rails via a spacing guide shaped to couple to the vertical rails.

17. The method of claim 16, wherein the spacing guide includes a first protrusion at a first end and a second protrusion at an opposing, second end, where the first protrusion and the second protrusion are shaped to seat within slots of the vertical rails, and a length between the first protrusion and the second protrusion is equal to a length of a shelf to be supported by the vertical rails.

18. The method of claim 13, further comprising coupling support brackets to the vertical rails and coupling a shelf to the support brackets.

19. The method of claim 18, further comprising coupling an end stop and/or an end container to the shelf.

20. The method of claim 13, further comprising:
removing the mobile storage assembly from the first vehicle cargo compartment; and
installing the mobile storage assembly to a second vehicle cargo compartment without modifying compartment rails of the second vehicle cargo compartment by:
aligning the rail mounts with a second set of openings of the vertical rails; and
coupling the rail mounts to the vertical rails and the compartment rails of the second vehicle cargo compartment by inserting fasteners through the openings of the second set of openings, bypassing the fasteners around the compartment rails of the second vehicle cargo compartment, and seating the fasteners within the rail mounts.
